(19) United States
(12) Patent Application Publication
(10) Pub. No.: US 2026/0297990 A1
(43) Pub. Date: Oct. 1, 2026

(54) ARRANGEMENT FOR THE ELECTRICAL ACTUATION OF AN INNER DOOR OF A VEHICLE WITH A MECHANICAL EMERGENCY ACTUATION

(71) Applicant: MERCEDES-BENZ GROUP AG, Stuttgart (DE)

(72) Inventors: Bernd PLOCHER, Rottenburg (DE); Rainer BAUER, Weil der Stadt (DE)

(21) Appl. No.: 19/477,965

(22) PCT Filed: Feb. 23, 2024
(86) PCT No.: PCT/EP2024/054697

§ 371 Date: Oct. 23, 2025

(30) Foreign Application Priority Data
Apr. 24, 2023 (DE) 10 2023 001 644.6

(51) Int. Cl. E05B 81/90; E05B 81/04

(52) U.S. Cl. CPC E05B 81/90; E05B 81/04

(57) ABSTRACT

An arrangement for the electrical actuation of a vehicle door from the inside with a mechanical emergency actuation includes an operating element and an electrical switching element for the electrical actuation of a door lock, which are connected to a power supply. When there is a voltage supply failure, a mechanical emergency actuation element is held in a rest position by an electrically activated switching actuator. When there is a power supply failure, the electrically deactivated switching actuator releases a kinematics mechanism of the mechanical emergency actuation element for independently setting an emergency actuation position.

### BACKGROUND AND SUMMARY OF THE INVENTION

Exemplary embodiments of the invention relate to an arrangement for the electrical actuation of an inner door of a vehicle with a mechanical emergency actuation, comprising an operating element and an electrical switching element for the electrical actuation of a door lock, which are connected to a power supply.

DE 10 2015 122 359 A1 discloses a door handle arrangement of a motor vehicle, comprising a carrier fixed to the door on the inner side, a handle arranged on the door on the outside, a door lock, which can be opened mechanically as well as electrically, and sensor electronics for detecting actuation of the handle. A mechanical retaining element exerts a retaining force on a second longitudinal end of the handle and holds the handle in a non-deflected position. The sensor electronics open the door when actuation with a force which is smaller than the retaining force is detected, wherein the handle remains non-deflected. When the handle is actuated with a force which is greater than the retaining force, the handle can be deflected into an emergency actuation position in which the handle mechanically opens the door.

Exemplary embodiments of the invention are directed to an arrangement for the electrical actuation of a driver's door from the inside with a mechanical emergency actuation, which can be reliably actuated when there is a voltage supply failure.

With the arrangement explained in the introduction for the electrical actuation of a vehicle door from the inside with a mechanical emergency actuation, comprising an operating element and an electrical switching element for the electrical actuation of a door lock, which are connected to a power supply, a mechanical emergency actuation element is held in a rest position by the electrically activated switching actuator, wherein when there is a power supply failure, the electrically deactivated switching actuator releases the mechanical emergency actuation element for independently setting an emergency actuation position. This has the advantage that disruption in the voltage supply enables electroless activation of a mechanical fallback level in the event of an emergency. Such an automatic activation function increases the accessibility and operability of the mechanical opening in the interior of the vehicle in the event of an emergency. Unintended actuation of the fallback level is reliably prevented, as operation of the actuation element to electrically open the side door and operation of the emergency actuation element are no longer connected.

In contrast to outer door handles, on which one has to pull to open in an emergency in order to outwardly open the vehicle door, pulling a door handle inwards would close the vehicle door and not open it, as desired in the event of an emergency. The mechanical emergency opening only has to unlock the door lock from the inside in the described case. A pull handle can be omitted.

Advantageously, the emergency actuation element is coupled to the kinematics mechanism to execute a failure movement from the rest position into the emergency actuation position. This kinematics mechanism allows opening of the vehicle door from the inside independent of the electrical actuator and without compromising the reliability of the actuation when there is a voltage supply failure. The kinematics mechanism can execute the failure movement by a pivot movement of a screw-like movement.

In one embodiment, the kinematics mechanism has a pivot point integral with the housing to release the emergency actuation element into the emergency actuation position. Therefore, the kinematics mechanism is decoupled from the electrical opening drive when there is a voltage supply failure, so that neither affects how the other one works.

In one variant, the kinematics mechanism comprises a locking lever, which has a pawl to hold the mechanical emergency actuation element. Therefore, lifting the operating element can simply trigger the mechanical fallback level.

In a particularly simple embodiment, the operating element is designed as a button element fixed in a carrier element, to the inner side of which the switching actuator connected to the power supply is joined, which guides the locking lever in the activated state. Therefore, a very compact and thus space-saving arrangement is realized.

It is advantageous when the mechanical emergency actuation element is pre-tensioned in its rest position by a spring drive of the kinematics mechanism which leans against an abutment, wherein the mechanical emergency actuation element can be pushed out of the pawl when the voltage supply to the switching actuator fails. Due to the spring drive, for example in the form of a torsion spring, it is ensured that the fallback level is automatically set and the emergency inner door handle is released.

In a further embodiment, the mechanical emergency actuation element and the button element are formed by the same actuation element. Therefore, the number of individual parts and thus the costs for the arrangement are reduced.

In a further variant, the electrically activated switching actuator is connected to the mechanical actuation element via a connecting rod-bracket device, wherein the bracket of the connecting rod-bracket device has a heart-shaped cam to guide the spring element. The rest state or the emergency actuation position are adopted only as a result of pressure on the spring element by means of the heart-shaped cam mechanics, wherein setting the emergency position can take place with low force.

In a further embodiment, the mechanical emergency actuation element is ergonomically embedded in an inner door covering. Thus, the mechanical emergency actuation element remains covered in the normal case and only becomes visible when an emergency situation occurs. Due to this design, design freedom in the interior of the vehicle is maintained, while the operating ergonomics of the electrical door opening function remains unchanged.

The design of the interior of the vehicle remains advantageously uninfluenced whenever the mechanical emergency actuation element is arranged on an underside of an armrest of the vehicle door.

Further advantages, features and characteristics result from the following description, in which at least one exemplary embodiment is described in detail—where appropriate, by referring to the drawing. Features described and/or depicted can form the subject matter of the invention on their own and/or in any meaningful combination, where appropriate also independently of the claims, and in particular can in addition also be subject matter of one or more separate application/s. Identical, similar and/or functionally identical parts are provided with identical reference numerals.

### BRIEF DESCRIPTION OF THE DRAWING FIGURES

The figures show:

FIG. 1 a schematic illustration of a side door of a vehicle having an opening function from the inside,

FIG. 2 a first exemplary embodiment of the arrangement according to the invention having an emergency opening function in the normal state,

FIG. 3 the first exemplary embodiment of the arrangement according to the invention having the emergency opening function in the emergency opening state,

FIG. 4 a further exemplary embodiment of the arrangement according to the invention,

FIG. 5 a further exemplary embodiment of the arrangement according to the invention.

### DETAILED DESCRIPTION

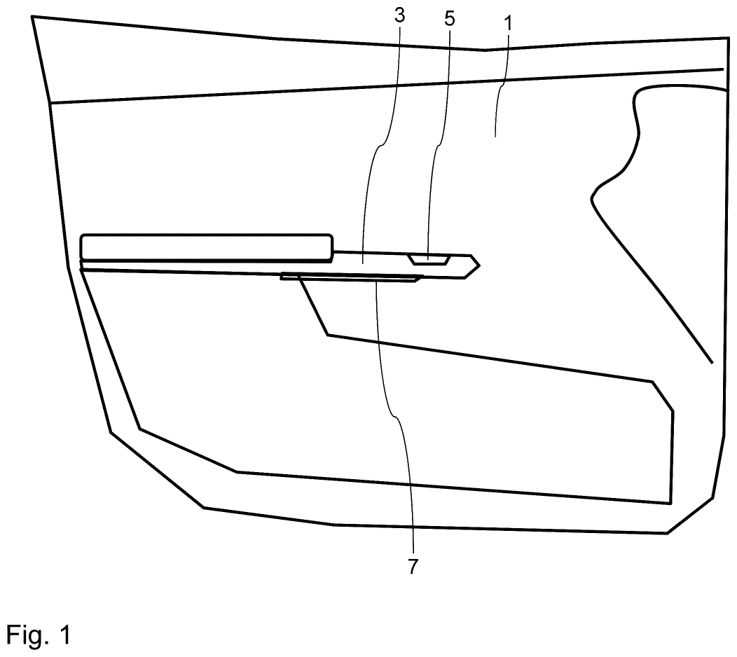

In FIG. 1, a schematic illustration of a side door of a vehicle having an opening function from the inside is illustrated. The side door 1 comprises an armrest 3, in which an arrangement for electrically opening the side door 1 is integrated. The arrangement forms a locking unit. Of the arrangement, FIG. 1 shows a button element 5 for the electrical door opening in a normal state and an emergency actuation element 7 for the mechanical emergency opening of the side door 1. Alternatively, however, instead of the button element 5, an operating element can also be used which can be pressed, pushed, and/or pulled.

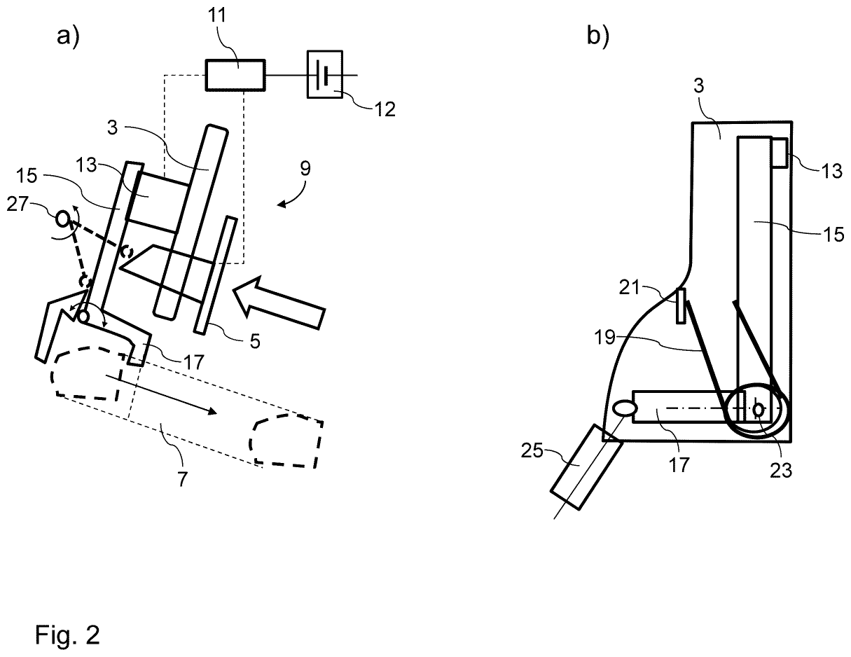

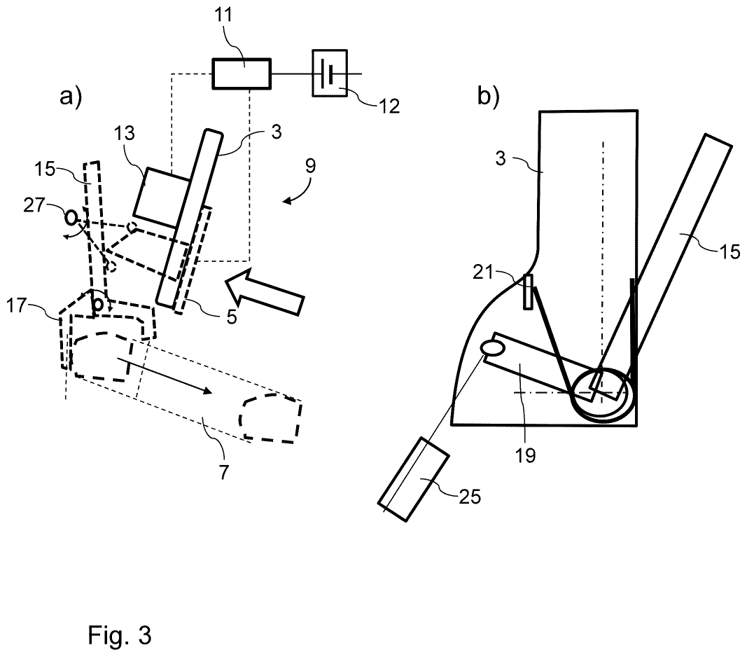

A first exemplary embodiment of the arrangement according to the invention is shown in FIGS. 2 and 3. FIG. 2 describes the arrangement 9 in the normal state and FIG. 3 in the emergency opening state. The button element 5 is arranged on a carrier element, for example the armrest 3, and is connected to an electrical switching element 11 which is joined to a voltage source 12 and which controls a lock controller (not illustrated further). This electrical switching element 11 additionally controls a switching actuator 13 in the form of an electromagnet or an electro-motor, which is positioned on the underside of the carrier element 3 (FIG. 2a). The switching actuator 13 can be energized continually or only in the moment when the button element 5 is pressed. In the energized state, the switching actuator 13 blocks a movement of a kinematics mechanism consisting of a locking lever 15 and a pawl 17 arranged on the locking lever 15. The pawl 17 serves as a mechanical latch for the emergency actuation element 7, preferably a lever, and fixes this in the normal state.

The locking lever 15 is pre-tensioned against an abutment 21 by a torsion spring 19, the pivot point 23 of which lies against the connection point between the locking lever 15 and the pawl 17, as can be seen from FIG. 2b, where a view of the armrest 3 from below is illustrated. The free end of the pawl 17 is connected to a Bowden cable 25 for actuating the door lock (not illustrated further). When the button element 5 is actuated in the energized state of the switching element 11, the switching actuator 13 fixes the locking lever 15. Therefore, the entire kinematics mechanism 15, 17 mounted in a pivot point 27 integral with the housing is rotated in a specified direction, whereby the lock (not shown) is actuated via the Bowden cable 25.

In the event of a power failure, which is shown in FIGS. 3a and 3b, the switching actuator 13 is also without power and releases the locking lever 15. This turns back about the pivot point 27 integral with the housing, wherein the pawl 17 releases the emergency actuation element 7 and the latter is pushed out about the pivot point 23 by the torsion spring 19, so that it becomes visible to the vehicle occupants below the armrest 3 for actuation.

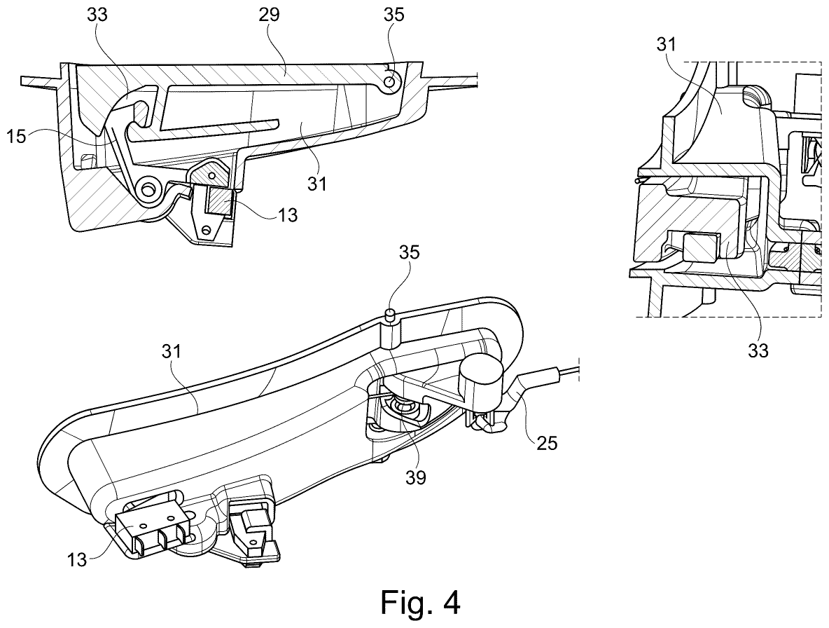

In FIG. 4, a further exemplary embodiment of the arrangement according to the invention is shown. Here, the functions of the button element and of the emergency actuation element are combined in an actuation element 29 arranged in a grip recess 31. To realize the button function, the switching actuator 13 is positioned below the free end of the actuation element 29 below the grip recess 31. Due to the button actuation of the actuation element 29, a stimulus for opening the door lock is created and simultaneously the switching actuator 13 is activated to secure the lever element 7 in its rest position. In the process, the actuation element 29 maintains its position and engages with its free end into a mechanical latch 33 designed on the underside of the actuation element 29. The actuation element 29 is guided at the opposite end in a bearing 35, which is coupled to the Bowden cable 25. When a rotational movement is executed about this bearing 35, the Bowden cable 25 for the lock opening is actuated.

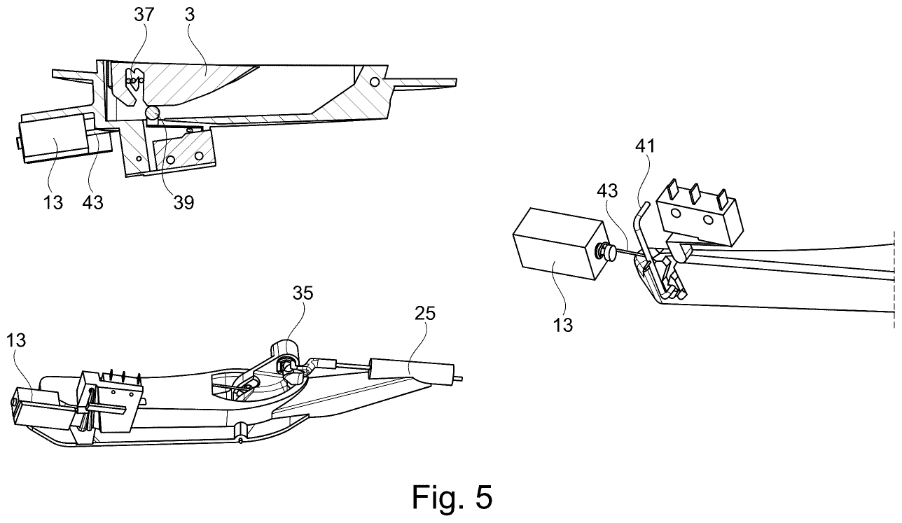

A further exemplary embodiment of the arrangement according to the invention is illustrated in FIG. 5. Here, a heart-shaped cam 37 is designed in the actuation element 29, in which the spring element 39, pre-tensioned against the locking lever 7, is guided, whereby a push-push process is realized when the locking lever 7 is actuated by the spring element 39, in the case of which little force is required (FIG. 5a). Additionally, the actuation element 29 is secured via a locking hook 41, which is connected to the switching actuator 13 via a connecting rod 43. When the voltage drops, the switching actuator 13 releases the connecting rod 43, whereby the locking hook 41 releases the actuation element 29.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. An arrangement for electrically actuating a door of a vehicle from an inside of the vehicle with a mechanical emergency actuation, the arrangement comprising:
an operating element;
an electrical switching element configured to electrically actuate a door lock of the vehicle door;
a power supply coupled to the operating element and the electrical switching element;
an electrically activated switching actuator; and
a mechanical emergency actuation element held in a rest position by the electrically activated switching actuator,
wherein when there is a failure of the power supply, the electrically activated switching actuator is deactivated and releases a kinematics mechanism of the mechanical emergency actuation element to independently set an emergency actuation position.

12. The arrangement of claim 11, wherein the mechanical emergency actuation element is coupled to the kinematics mechanism to execute a failure movement from the rest position into the emergency actuation position.

13. The arrangement of claim 11, wherein the kinematics mechanism has a pivot point integral with a housing to release the mechanical emergency actuation element into the emergency actuation position.

14. The arrangement of claim 11, wherein the kinematics mechanism comprises a locking lever and a pawl configured to hold the mechanical emergency actuation element.

15. The arrangement of claim 14, wherein the operating element is a button element fixed in a carrier element, wherein the electrically activated switching actuator is joined to an inner side of the carrier element to guide the locking lever in an activated state of the electrically activated switching actuator.

16. The arrangement of claim 14, wherein the mechanical emergency actuation element is pre-tensioned in a rest position by a spring drive of the kinematics mechanism, wherein the spring drive leans against an abutment and pushes the mechanical emergency actuation element out of the pawl when the power supply to the switching actuator fails.

17. The arrangement of claim 15, wherein the mechanical emergency actuation element and the button element form a common mechanical actuation element.

18. The arrangement of claim 17, wherein the electrically activated switching actuator is connected to the common mechanical actuation element via a connecting rod-bracket device, wherein a bracket of the connecting rod-bracket device has a heart-shaped cam configured to guide a spring element.

19. The arrangement of claim 11, wherein the mechanical emergency actuation element is embedded ergonomically into an inner door covering.

20. The arrangement of claim 11, wherein the mechanical emergency actuation element is positioned on an underside of a vehicle armrest.

21. A vehicle comprising:
a vehicle door; and
an arrangement for electrically actuating the vehicle door from an inside of the vehicle with a mechanical emergency actuation, the arrangement comprising
an operating element;
an electrical switching element configured to electrically actuate a door lock of the vehicle door;
a power supply coupled to the operating element and the electrical switching element;
an electrically activated switching actuator; and
a mechanical emergency actuation element held in a rest position by the electrically activated switching actuator,
wherein when there is a failure of the power supply, the electrically activated switching actuator is deactivated and releases a kinematics mechanism of the mechanical emergency actuation element to independently set an emergency actuation position.
